(19) United States
(12) Patent Application Publication
(10) Pub. No.: US 2025/0068108 A1
(43) Pub. Date: Feb. 27, 2025

(54) IMAGE FORMING APPARATUS, METHOD FOR CONTROLLING IMAGE FORMING APPARATUS, AND STORAGE MEDIUM

(71) Applicant: CANON KABUSHIKI KAISHA, Tokyo (JP)

(72) Inventor: HIDESHI ICHIMI, Ibaraki (JP)

(21) Appl. No.: 18/801,126

(22) Filed: Aug. 12, 2024

(30) Foreign Application Priority Data
Aug. 21, 2023 (JP) 2023-134174

(51) Int. Cl. G03G 15/00; B65H 1/04

(52) U.S. Cl. CPC G03G 15/5029; B65H 1/04; G03G 15/5004; G03G 15/5062; B65H 2511/416

(57) ABSTRACT

An image forming apparatus comprises one or more memories that store a set of instructions, one or more processors that execute the set of instructions to: determine whether a sheet having first sheet information is a sheet for which adjustment of a first print control parameter is performable, perform, in a case where the sheet having the first sheet information is a sheet for which the adjustment of the first print control parameter is performable, control to print a first adjustment chart and control to scan the printed first adjustment chart, and acquire an adjustment value for the first print control parameter based on a result of a scan, register, in a case where the adjustment value for the first print control parameter is acquired, second sheet information obtained by reflecting the adjustment value for the first print control parameter in the first sheet information.

### BACKGROUND

### Field

The present disclosure relates to an image forming apparatus, a method for controlling the image forming apparatus, and a storage medium.

### Description of the Related Art

Printed documents with high quality can be obtained by using a method for specifying a paper type (sheet type) of a sheet fed in a print job from a paper type database (media library) stored in an image forming apparatus in advance, and using print control parameters for the paper type in image forming control.

There is known an image forming apparatus that can copy a previously-stored paper type, and register a user-defined sheet in which print control parameters for the paper type are optionally changed by the user in a media library in order to support a wide variety of paper types.

Japanese Patent Application Laid-Open No. 2022-26815 discusses a technique for measuring and specifying a paper type as a copy source of a user-defined sheet by a paper type detection sensor (media sensor) that measures a feature amount of a sheet, such as surface property and a basis weight, on a sheet conveyance path of an image forming apparatus.

The print control parameters are changed by the user after the user-defined sheet is created. Thus, it is difficult for the user who is not conscious of the paper type to change the print control parameters. A plurality of adjustment menus for changing the print control parameters is provided, and some of the adjustment menus are not performable depending on the paper type. Thus, it is difficult for the user to select an adjustment menu performable for the paper type.

### SUMMARY

The present disclosure is directed to a technique for easily registering adjustment values of print control parameters when sheet information is registered.

According to an aspect of the present disclosure, an image forming apparatus comprises one or more memories that store a set of instructions, one or more processors that execute the set of instructions to: determine whether a sheet having first sheet information is a sheet for which adjustment of a first print control parameter is performable, perform, in a case where the sheet having the first sheet information is a sheet for which the adjustment of the first print control parameter is performable, control to print a first adjustment chart and control to scan the printed first adjustment chart, and acquire an adjustment value for the first print control parameter based on a result of a scan, register, in a case where the adjustment value for the first print control parameter is acquired, second sheet information obtained by reflecting the adjustment value for the first print control parameter in the first sheet information

Further features of the present disclosure will become apparent from the following description of exemplary embodiments with reference to the attached drawings.

### BRIEF DESCRIPTION OF THE DRAWINGS

FIG. 1 is a cross-sectional view illustrating an example of a configuration of an image forming apparatus.

FIG. 2 is a block diagram illustrating an example of a configuration of main components controlled by a central processing unit (CPU).

FIG. 3 is a cross-sectional view illustrating an example of a configuration of a fixing unit.

FIG. 4 is a diagram illustrating an example of a configuration of a media sensor.

FIGS. 5A and 5B are explanatory diagrams illustrating a user-defined sheet.

FIGS. 6A and 6B are explanatory diagrams illustrating a user-defined sheet.

FIG. 7 is an explanatory diagram illustrating a user-defined sheet.

FIGS. 8A and 8B are explanatory diagrams illustrating a user-defined sheet creation flow screen.

FIGS. 9A and 9B are explanatory diagrams illustrating a user-defined sheet creation flow screen.

FIGS. 10A and 10B are explanatory diagrams illustrating a user-defined sheet creation flow screen.

FIGS. 11A and 11B are explanatory diagrams illustrating a user-defined sheet creation flow screen.

FIG. 12 is a flowchart illustrating registration of a new user-defined sheet.

### DESCRIPTION OF THE EMBODIMENTS

An exemplary embodiment is described below with reference to the drawings. The exemplary embodiment described below is illustrative, and the present disclosure is not limited to the following exemplary embodiment. In the following exemplary embodiment, the same components are described while being denoted by the same reference numerals and signs.

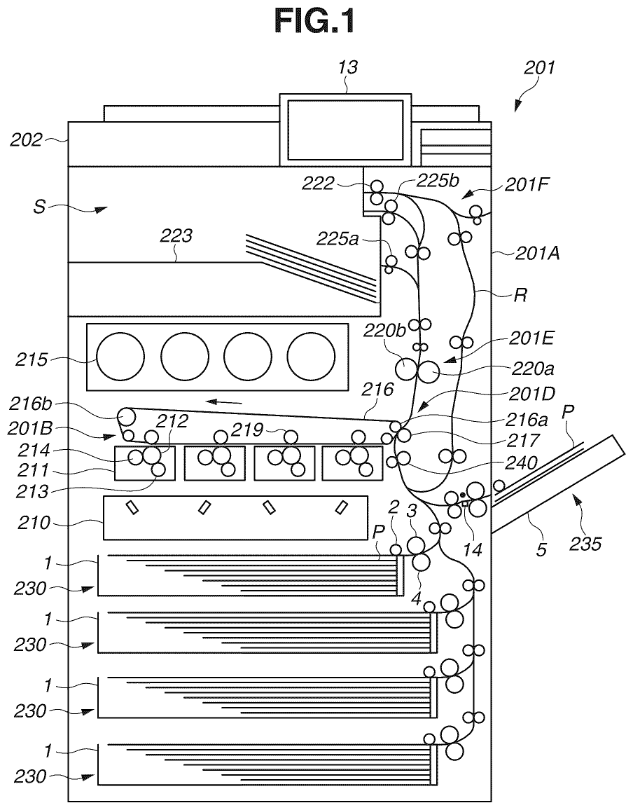

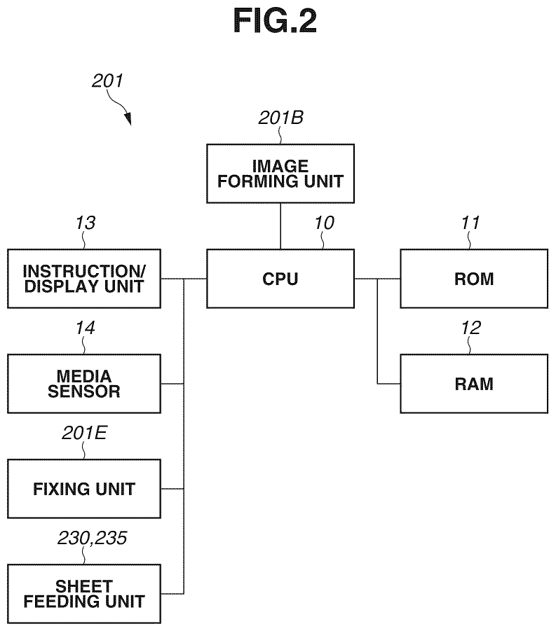

FIG. 1 is a cross-sectional view illustrating an example of a configuration of an image forming apparatus 201 according to an exemplary embodiment. FIG. 2 is a diagram illustrating main components controlled by a central processing unit (CPU) 10 of the image forming apparatus 201 according to the present exemplary embodiment. A basic configuration and operation of the image forming apparatus 201 according to the present exemplary embodiment are first described with reference to FIGS. 1 and 2.

In the image forming apparatus 201 illustrated in FIG. 2, the CPU 10 is connected to an instruction/display unit 13, a media sensor 14, a fixing unit 201E, a cassette sheet feeding unit 230, a manual sheet feeding unit 235, an image forming unit 201B, a read only memory (ROM) 11, and a random access memory (RAM) 12.

The CPU 10 is a control unit controlling the entire image forming apparatus 201. The ROM 11 stores control programs according to the present exemplary embodiment, initial values for various kinds of setting values, and the like. The CPU 10 executes the control programs according to the present exemplary embodiment read out from the ROM 11, thereby realizing a procedure of image formation and a procedure of a flowchart described below.

The RAM 12 stores various information under the control of the CPU 10. Although details are described below, the RAM 12 stores print control parameters for each sheet type in a first storage area. The RAM 12 is desirably a rewritable memory not requiring a data refresh operation.

As described below, in a case where the user changes print control parameters corresponding to a referred sheet type, the CPU 10 additionally stores the changed print control parameters as user-defined print control parameters corresponding to the sheet type in the first storage area.

The instruction/display unit 13 includes a panel that can display an operation screen, and buttons. When an instruction to start print operation or the like is input, the instruction/display unit 13 transmits information on the instruction to the CPU 10. The instruction to start print operation or the like may be input from an external apparatus, such as a personal computer, a tablet terminal, and a smartphone, connected through a network or the like (not illustrated), in addition to the case where the instruction is input by the user via the instruction/display unit 13.

When the information on the instruction to start printing operation is input to the CPU 10, the CPU 10 drives and controls a feeding conveyance motor (not illustrated) to feed and convey a sheet in accordance with the instruction information. The CPU 10 also controls image formation (printing) to be performed by the image forming unit 201B by setting print control parameters to the image forming unit 201B. The image forming unit 201B performs printing on the sheet based on the print control parameters set by the CPU 10.

In FIG. 1 illustrates the image forming apparatus 201, an image forming apparatus main body 201A, and the image forming unit 201B for forming an image on a sheet. An image reading apparatus 202 is installed substantially horizontally above the image forming apparatus main body 201A, and a sheet discharge space S for discharging sheets is provided between the image reading apparatus 202 and the image forming apparatus main body 201A.

Each cassette sheet feeding unit 230 feeds a sheet P from a sheet feeding cassette 1 that is a sheet storage unit storing the sheet P. The cassette sheet feeding unit 230 includes a pickup roller 2 as a sheet feeding portion, and a separation portion including a feed roller 3 and a retard roller 4 for separating sheets P delivered from the pickup roller 2.

The manual sheet feeding unit 235 feeds a sheet P from a manual sheet feeding tray 5 that is a unit holding the sheet P. The manual sheet feeding unit 235 includes a sheet feeding portion and a separation portion as with the cassette sheet feeding units 230.

The image forming unit 201 is of a four-drum full-color system, and includes a laser scanner 210 and four process cartridges 211 forming toner images of four colors of yellow (Y), magenta (M), cyan (C), and black (K).

Each of the process cartridges 211 includes a photosensitive drum 212, a charger 213 as a charging unit, and a developing device 214 as a developing unit. The image forming unit 201B also includes a secondary transfer unit 201D and the fixing unit 201E provided above the process cartridges 211. Toner cartridges 215 supply toner to the developing devices 214.

The secondary transfer unit 201D includes a transfer belt 216 stretched between a driving roller 216a and a tension roller 216b. First transfer rollers 219 are provided inside the inner circumference of the transfer belt 216 at positions facing the respective photosensitive drums 212 and are in contact with the transfer belt 216.

The transfer belt 216 rotates in an arrow direction by the driving roller 216a driven by a driving unit (not illustrated). A secondary transfer roller 217 that transfers a color image formed on the transfer belt 216 to a sheet P is provided at a position facing the driving roller 216a of the secondary transfer unit 201D.

The fixing unit 201E is disposed above the secondary transfer roller 217. A first discharge roller pair 225a, a second discharge roller pair 225b, and a double-sided reversing unit 201F are disposed at an upper left part of the fixing unit 201E. The double-sided reversing unit 201F includes a reverse roller pair 222 that can rotate in forward and reverse directions, and a reconveyance path R conveying the sheet P on which an image has been formed on one of its surfaces, to the image forming unit 201B, again.

The instruction/display unit 13 receiving operation from the user is provided at an upper part of the image forming apparatus 201.

### <Operation of Image Forming Apparatus>

Image forming operation of the image forming apparatus 201 is described. When the image forming apparatus 201 receives image data on a document which is to be printed, the image data is subjected to image processing and is then converted into an electric signal, and the electric signal is transmitted to the laser scanner 210 of the image forming unit 201B.

In the image forming unit 201B, surfaces of the photosensitive drums 212 that are uniformly charged to predetermined polarity and potential by the chargers 213 are sequentially exposed to laser. As a result, electrostatic latent images of yellow, magenta, cyan, and black are sequentially formed on the photosensitive drums 212 of the respective process cartridges 211.

Thereafter, the electrostatic latent images are visualized by being developed with color toners, and the color toner images on the respective photosensitive drums 212 are sequentially superimposed and transferred onto the transfer belt 216 by primary transfer bias applied to the primary transfer rollers 219. As a result, the toner images are formed on the transfer belt 216.

Further, in parallel with the toner image forming operation, sheets P are conveyed one by one to a registration roller pair 240 from any of the cassette sheet feeding units 230, and skew of each sheet P is corrected by the registration roller pair 240. After skew is corrected, the sheet P is conveyed to the secondary transfer unit 201D by the registration roller pair 240. At the secondary transfer unit 201D, the toner images are collectively transferred onto the sheet P by a secondary transfer bias applied to the secondary transfer roller 217.

Thereafter, the sheet P on which the toner images have been transferred is conveyed to the fixing unit 201E, the toners of respective colors are fused and mixed by receiving heat and pressure at a roller nip portion formed by a pressing roller 220a and a heating roller 220b, and the toner images are fixed to the sheet P as a color image.

At this time, sticking force to the heating roller 220b is generated on the sheet P by adhesive force of the fused toner. When stiffness (rigidity) of the sheet P is low, the sheet P is wound around the rotating heating roller 220b. Thus, a separation plate for separating sheets P is provided on a downstream side of the heating roller 220b.

Thereafter, the sheet P on which the image has been fixed is discharged to the discharge space S by a first discharge roller pair 225a and a second discharge roller pair 225b provided on a downstream side of the fixing unit 201E, and is loaded to a loading portion 223 provided below the discharge space S. In a case where images are formed on both surfaces of the sheet P, after the image is fixed, the sheet P is conveyed to the reconveyance path R by the reverse roller pair 222, and is conveyed to the image forming unit 201B, again.

The media sensor 14 is a paper type detection sensor that is provided on a sheet conveyance path of the manual sheet feeding unit 235 and detects a type (paper type) of a sheet fed through the sheet conveyance path. The paper type is used in the same meaning as a type of a sheet and a sheet type here. The media sensor 14 detects surface property, a thickness, and the like of the conveyed sheet, and the CPU 10 determines a sheet type from a result of the detection. In the present exemplary embodiment, if it is expressed that the media sensor 14 detects or determines a sheet type, this means that the media sensor 14 detects the surface property, the thickness, and the like of the sheet and the CPU 10 determines a sheet type based on the result of the detection by the media sensor 14. Details thereof are described below.

### <Description of Fixing Unit>

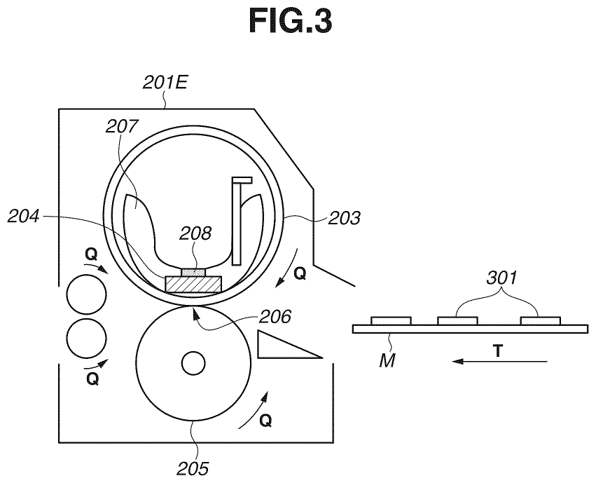

FIG. 3 is a diagram illustrating a configuration and fixation of the fixing unit 201E. The fixing unit 201E is an assembly that includes a heater holder 207, a fixing heater 204 and a fixing film 203 as an elastic layer. The fixing heater 204 is disposed on and fixed to a lower surface of the heater holder 207 along a longitudinal direction (direction perpendicular to the drawing sheet) of the heater holder 207.

Arrows Q in FIG. 3 each indicate a rotation direction. An arrow T in FIG. 3 indicates a moving direction of a sheet M on which toner 301 is applied. A pressing roller 205 is disposed in such a manner that both ends of a core metal of the pressing roller 205 are rotatably borne between side plates of the fixing unit 201E.

In the fixing unit 201E, the fixing heater 204 is arranged in parallel with the pressing roller 205 in a state where the fixing heater 204 faces the pressing roller 205, and both ends of the heater holder 207 are pressed at predetermined pressing force by an urging mechanism (not illustrated). Accordingly, a surface of the fixing heater 204 is brought into press contact with the pressing roller 205 with the fixing film 203 interposed therebetween against elasticity of the pressing roller 205, and a fixing nip portion 206 having a predetermined width is formed.

The pressing roller 205 is rotationally driven at a predetermined circumferential speed in a counterclockwise direction indicated by the arrow Q by a driving mechanism (not illustrated). The fixing heater 204 includes a resistance heating element on a ceramic substrate. A temperature detection sensor 208 is in contact with the fixing heater 204.

The CPU 10 detects a temperature of the fixing heater 204 based on an output of the temperature detection sensor 208, and controls power to be supplied to the fixing heater 204 such that the temperature of the fixing heater 204 becomes a predetermined target temperature. The target temperature of the fixing heater 204 is determined based on a sheet type to be fed, an environmental temperature, and the like.

The CPU 10 determines the target temperature of the fixing heater 204 based on the set sheet type input from the instruction/display unit 13 or the sheet type detected by the media sensor 14. In a case of thin paper, a target temperature of the fixing unit 201E is set to a low temperature as compared with a case of regular paper, whereas in a case of thick paper, the target temperature of the fixing unit 201E is set to a high temperature as compared with the case of regular paper.

### <Description of Media Sensor>

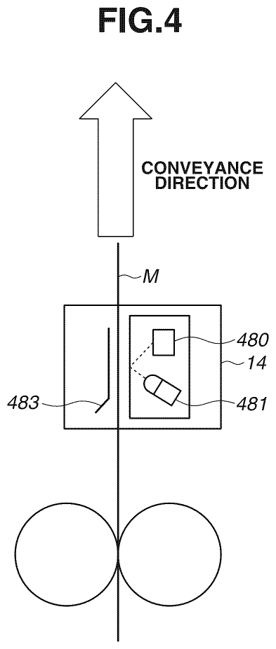

FIG. 4 is a diagram illustrating an example of a configuration of the media sensor 14. A light-emitting diode (LED) 481 as a light emitting element, and a photodiode 480 as a light receiving element are disposed inside the media sensor 14.

The photodiode 480 can detect a quantity of reflected light of light emitted from the LED 481. The media sensor 14 further includes a guide portion 483 along which the sheet M is conveyed.

The CPU 10 receives an input signal of the photodiode 480 as an output value of the media sensor 14. The CPU 10 can determine the type of the fed sheet based on a difference of a received value due to the surface property and the thickness of each sheet. The CPU 10 optimally controls an image forming speed and the target temperature of the fixing unit 201E based on the detected sheet type.

As described above, in the present exemplary embodiment, the CPU 10 determines the sheet type by using the media sensor 14, and thus, the user is not required to perform setting of a sheet type without concern for the sheet type. Thus, in the image forming apparatus 201 according to the present exemplary embodiment, a mode in which a sheet type is determined by the media sensor 14 and print control parameters and the like are automatically set based on the determined sheet type (hereinafter, referred to as media automatic setting mode) is prepared.

On the other hand, the image forming apparatus 201 according to the present exemplary embodiment also has a mode in which the user manually sets a sheet type to be used (hereinafter, referred to as media manual setting mode) as with the existing technique. The user can set in advance the media automatic setting mode or the media manual setting mode to each sheet feeding unit by operating the instruction/display unit 13.

The media automatic setting mode is set as a default mode. A setting value indicating whether the set mode is the media automatic setting mode or the media manual setting mode is stored in the RAM 12.

The above-described configuration of the media sensor 14 is illustrative, and the media sensor 14 is not limited to the configuration. For example, in addition to the light emitting element and the light receiving element, an ultrasonic sensor, such as a piezoelectric element, may be combined, and the media sensor 14 may include the foregoing other components.

### <Description of User-Defined Sheet>

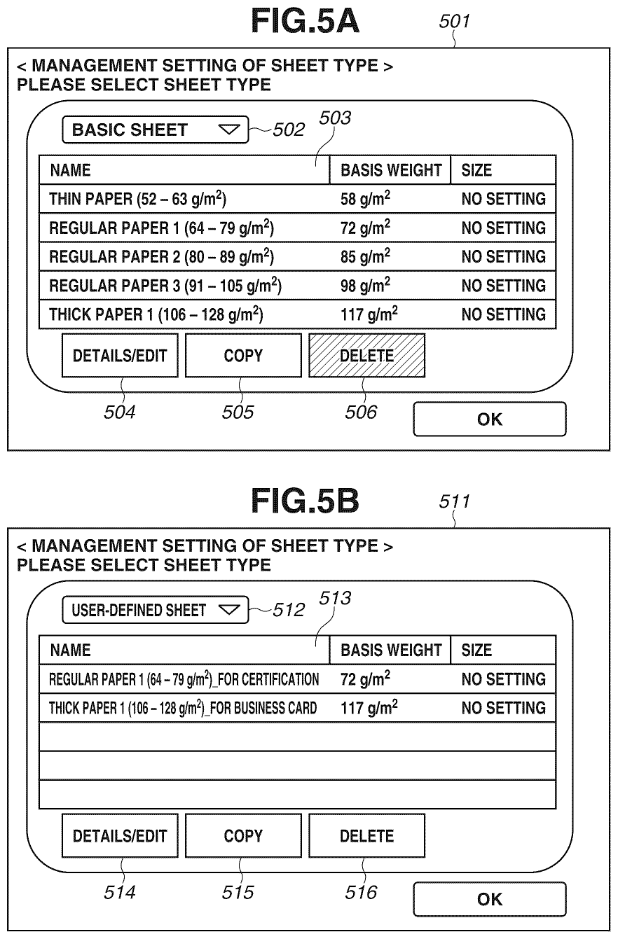

A method for creating a user-defined sheet is described with reference to FIG. 5A to FIG. 7. FIG. 5A to FIG. 7 are diagrams each illustrating a screen to be displayed on the instruction/display unit 13. In the present exemplary embodiment, the user-defined sheet refers to a sheet type uniquely set by the user, and print control parameters (control parameters for image formation) such as definition of features including a basis weight and surface property, and a fixing temperature can be set to a sheet type.

In the present exemplary embodiment, the user-defined sheet is created in a manner described below based on print control parameters of a basic sheet prepared in advance. The print control parameters of the basic sheet are stored in the first storage area of the RAM 12, and the print control parameters of the user-defined sheet are added to and stored in the first storage area of the RAM 12 by the CPU 10.

FIG. 5A is a diagram illustrating an example of a screen 501 displaying a list of basic sheets selectable when a user-defined sheet is set. The user can select any of “basic sheet”, “user-defined sheet”, and “all” using a pulldown menu 502 in FIG. 5A. The CPU 10 reads out information on the sheets stored in the RAM 12 in response to selection in the pulldown menu 502, and displays the information on the sheets in an area 503. The user selects an optional basic sheet from the sheets displayed in the area 503, and presses a copy button 505, thereby registering a user-defined sheet as a new sheet with a new name based on registration information on a user-defined sheet. When the user selects an optional basic sheet from the sheets displayed in the area 503, and presses a detail/edit button 504, the user can check details of the basic sheet. Because the basic sheet cannot be deleted, a deletion button 506 is hatched so as not to be pressed.

FIG. 5B is a diagram illustrating an example of a screen 511 displayed when a user-defined sheet is selected using a pulldown menu 512. A list of user-defined sheets read out from the RAM 12 by the CPU 10 is displayed in an area 513. The user selects an optional user-defined sheet from the sheets displayed in the area 513, and presses a detail/edit button 514, thereby changing sheet parameters, such as the basis weight and the size. Further, by selecting an optional user-defined sheet from the sheets displayed in the area 513, and pressing a copy button 515, the user can register a new user-defined sheet based on a registered user-defined sheet.

Further, when the user selects an optional user-defined sheet from the sheets displayed in the area 513, and presses a delete button 516, the user can delete the selected user-defined sheet.

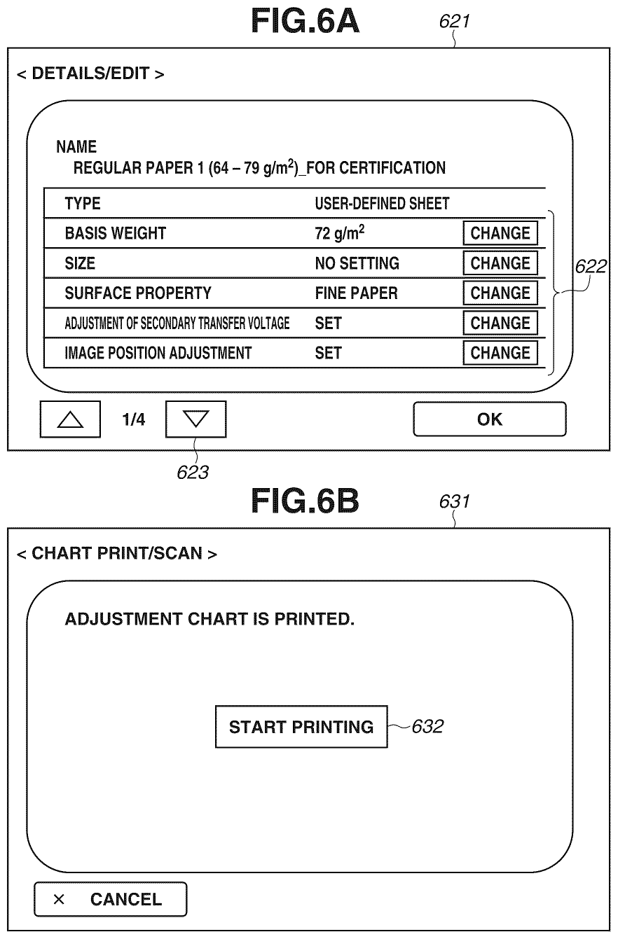

FIG. 6A is a diagram illustrating an example of a screen 621 displayed when the detail/edit button 504 illustrated in FIG. 5A or the detail/edit button 514 illustrated in FIG. 5B is pressed. In the screen 621, setting of the parameters for controlling each sheet type can be checked and edited. As a name, a name registered in advance is displayed in a case of a basic sheet, and a name registered by the user is displayed in a case of a user-defined sheet. As a type, whether it is a basic sheet or a user-defined sheet is displayed. As a basis weight, a weight of the sheet is displayed. As a size, a size of the sheet is displayed. As surface property, a type indicating feature of a surface shape of the sheet is displayed. As adjustment of a secondary transfer voltage and image position adjustment, “no setting” or “set” is displayed. Adjustment values for the adjustment of the secondary transfer voltage and the image position adjustment are described next.

### <Description of Adjustment>

The secondary transfer voltage is a value of a voltage for transferring toner on an intermediate transfer body, and is set to a value of magnitude not causing abnormal electrical discharge. For example, in a case where a sheet of a type having a moisture content and a resistance value largely different from standard values is used for printing, optimum transfer cannot be performed with a default value of the secondary transfer voltage in some cases.

In a case where the resistance value of the sheet used for printing is greater than the standard value, the default value of the secondary transfer voltage is insufficient, and thus, it is desirable to apply the secondary transfer voltage of a value greater than the default value.

In a case where the moisture content of the sheet used for printing is less than the standard value, abnormal electrical discharge easily occurs, and image defect caused by the abnormal electrical discharge occurs as a result. Therefore, it is desirable to apply the secondary transfer voltage of a value less than the default value.

As described above, it is necessary to control the secondary transfer voltage to an appropriate value based on the type of the sheet used for printing. To register an appropriate adjustment value for the sheet, a coarse adjustment chart or a fine adjustment chart (not illustrated) is printed, the printed chart is read, and an adjustment value for the secondary transfer voltage is determined such that transfer efficiency is within a prescribed range.

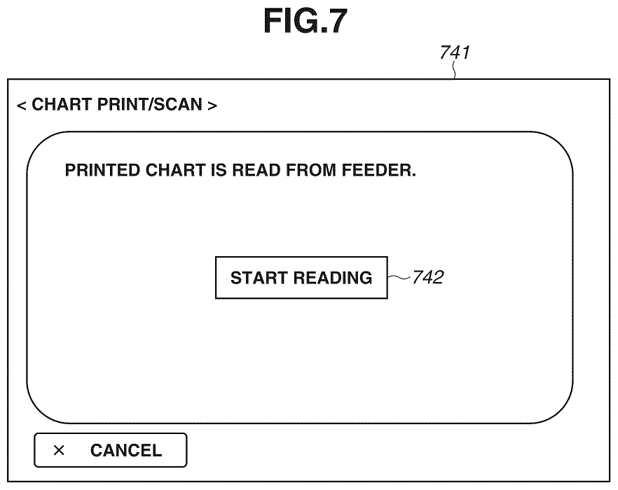

To newly register or re-register an adjustment value for the secondary transfer voltage, if the user presses a change button 622 illustrated in FIG. 6A, the screen transitions to a chart print screen 631 illustrated in FIG. 6B. When a print start button 632 is pressed, the CPU 10 prints the chart and displays a screen 741 illustrated in FIG. 7.

The user places the printed chart on a feeder and presses a reading start button 742. When the reading start button 742 is pressed, the CPU 10 scans the chart, calculates an adjustment value, and stores the adjustment value in the RAM 12 in association with the sheet being registered.

When the adjustment value is stored, “adjustment of secondary transfer voltage” is displayed as “set” in the screen 621 illustrated in FIG. 6A.

An item “image position adjustment” in the screen 621 is an adjustment item for adjusting an image position on a front surface and a rear surface of the sheet. In the image position adjustment, an adjustment value for an image position from an upper end and a left end on each of the front surface and the rear surface is set as a moving amount. In the image position adjustment, the image forming apparatus 201 also prints a chart for adjusting an image position on each of the front surface and the rear surface, and reads the printed chart, thereby calculating an adjustment value. To newly register or re-register an adjustment value for the image position, the user presses the change button 622 illustrated in FIG. 6A, and prints and reads an image position adjustment chart through the screen 631 illustrated in FIG. 6B and the screen 741 illustrated in FIG. 7. The CPU 10 thus calculates an adjustment value and stores the adjustment value in the RAM 12 in association with the sheet being registered. When the adjustment value is stored, “image position adjustment” is displayed as “set” in the screen 621 illustrated in FIG. 6A.

Although, in the screen 621, the name, the type, the basis weight, the size, the surface property, the adjustment of the secondary transfer voltage, and the image position adjustment are illustrated as examples, various kinds of other parameters are recorded and can be checked by pressing of a button 623.

The flow of processing in which a user-defined sheet is copied from a basic sheet or another user-defined sheet already registered by pressing the copy button 505 or 515 is described above. In addition, a method for easily determining a user-defined sheet without making the user conscious of the sheet type by using the media sensor 14 is also provided. The details thereof are described below.

### <Description of User-Defined Sheet Creation Flow>

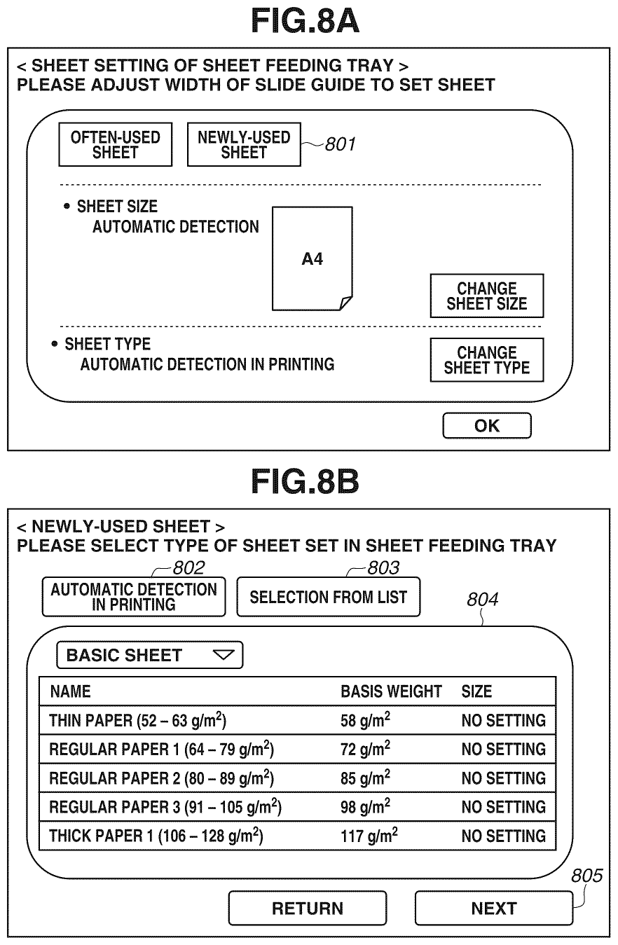

FIG. 8A to FIG. 11B are diagrams illustrating examples of screens for creating a user-defined sheet without making the user conscious of the sheet type, and these screens are displayed on the instruction/display unit 13.

FIG. 8A is a diagram illustrating an example of a sheet setting screen to be displayed on the instruction/display unit 13 when the CPU 10 detects that a sheet is placed on the sheet feeding tray 5. In FIG. 8A, a size and a type of the sheet placed on the sheet feeding tray are settable. In the screen illustrated in FIG. 8A, when the user presses a “newly-used sheet” button 801, a user-defined sheet creation flow is started, and the screen is shifted to a screen illustrated in FIG. 8B.

In the screen illustrated in FIG. 8B, a screen for selecting a sheet type as a base for creating a user-defined sheet is displayed. An “automatic detection in printing” button 802 is a button for automatically detecting a sheet type by using the media sensor and creating a user-defined sheet based on the detected sheet type.

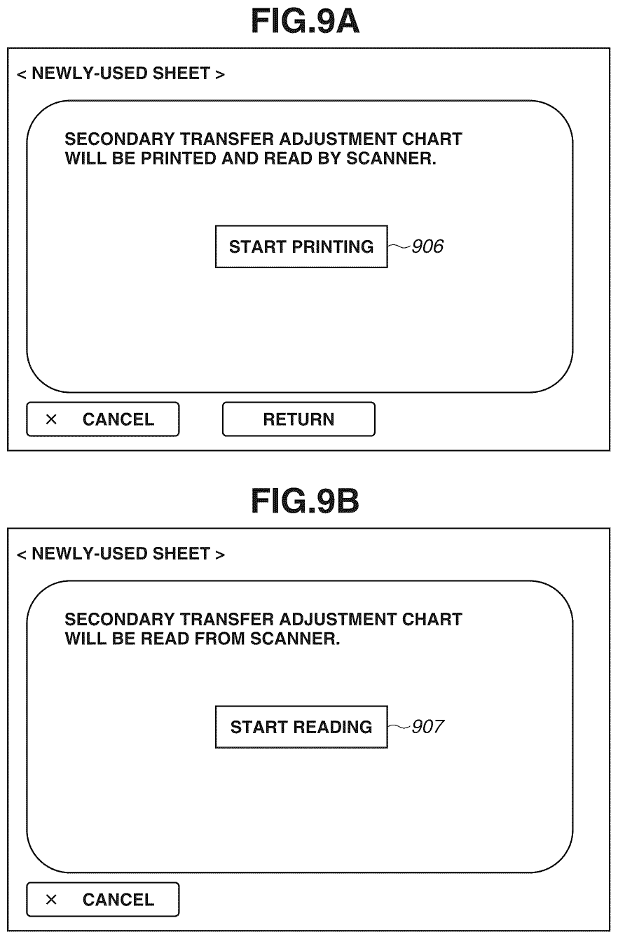

In a case where a “selection from list” button 803 is pressed, the user can select a sheet type as a base for creating a user-defined sheet from a sheet type list 804. When a “next” button 805 is pressed, a secondary transfer adjustment screen illustrated in FIG. 9A is displayed.

FIG. 9A illustrates a screen for instructing to start printing of a secondary transfer adjustment chart. When a print start button 906 illustrated in FIG. 9A is pressed, a chart for performing secondary transfer adjustment can be printed.

In a case where the “automatic detection in printing” button 802 is selected in the sheet type selection screen illustrated in FIG. 8B, the media sensor 14 measures a first sheet on which the secondary transfer adjustment chart is to be printed when the first sheet is fed, and determines a sheet type. The CPU 10 copies the determined sheet type, and registers a user-defined sheet in the paper type database. At the time point, the CPU 10 stores, among measurement data obtained by measuring the sheet by the media sensor 14, data settable to print control parameters, for example, a basis weight in the user-defined sheet.

In response to pressing of the print start button 906 illustrated in FIG. 9A, the CPU 10 prints the secondary transfer adjustment chart based on the print control parameters of the registered user-defined sheet. Thereafter, the CPU 10 displays a screen for issuing an instruction to start reading the printed secondary transfer adjustment chart, as illustrated in FIG. 9B.

In response to pressing of a reading start button 907 illustrated in FIG. 9B, the CPU 10 scans the secondary transfer adjustment chart, and calculates an adjustment value. The calculated adjustment value is stored in the print control parameters of the user-defined sheet.

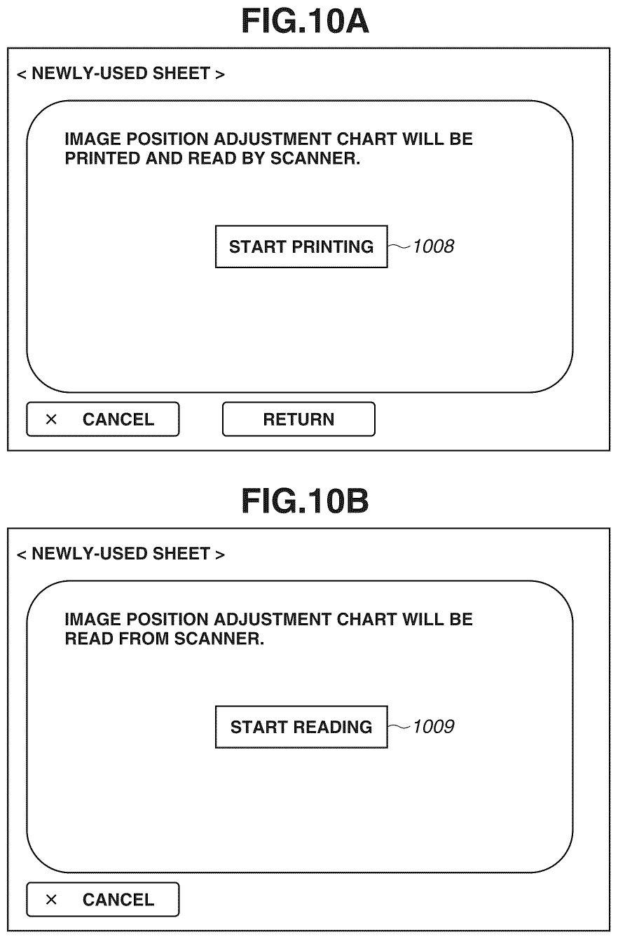

Thereafter, in a similar manner to the secondary transfer adjustment chart, in response to a print start button 1008 illustrated in FIG. 10A, the CPU 10 prints an image position adjustment chart based on the print control parameters of the registered user-defined sheet. Thereafter, in response to pressing of a reading start button 1009 illustrated in FIG. 10B, the CPU 10 scans the printed image position adjustment chart, calculates an adjustment value, and stores the adjustment value in the print control parameters of the user-defined sheet.

In the present exemplary embodiment, the adjustment of the secondary transfer voltage and the image position adjustment are described as examples; however, other adjustment menus may be used as long as the adjustment menus can be implemented in association with a sheet, and a plurality of types of adjustment may be collectively performed in the user-defined sheet registration flow.

In the present exemplary embodiment, furthermore, both the adjustment of the secondary transfer voltage and the image position adjustment are performed; however, the adjustment of the secondary transfer voltage or the image position adjustment may not be performable depending on the size and the type of a sheet. In this case, the CPU 10 automatically determines performable adjustment based on the size and the type of the sheet, and performs screen display control for the adjustment of the secondary transfer voltage or the image position adjustment.

In the case where the “automatic detection in printing” button 802 is selected in the sheet type selection screen illustrated in FIG. 8B, it is necessary to measure a sheet and to determine a sheet type by the media sensor 14 when the sheet on which the secondary transfer adjustment chart is to be printed is fed. Thus, although the adjustment of the secondary transfer voltage cannot be performed depending on the determined sheet type, one sheet may be fed before adjustment, and an adjustment menu thereafter may be determined.

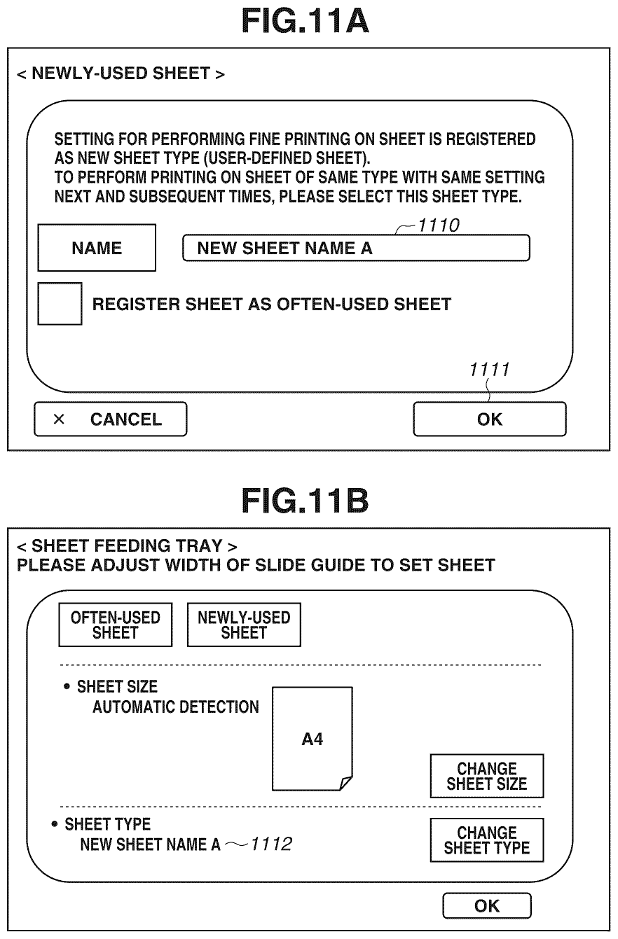

Next, the CPU 10 performs control to display a user-defined sheet name input screen illustrated in FIG. 11A. The user enters an optional name in a name entry field 1110, and presses an OK button 1111. The registration flow thus ends. At this time, the CPU 10 changes the name of the user-defined sheet in the paper type database to the name input in FIG. 11A, and displays a screen illustrated in FIG. 11B.

FIG. 11B illustrates a sheet setting screen for the sheet feeding tray 5 that is same as the screen illustrated in FIG. 8A, but after the user-defined sheet is created, the user-defined sheet created in the user-defined sheet creation flow is set in a sheet type 1112. The transition of screens in the user-defined sheet creation flow is described above.

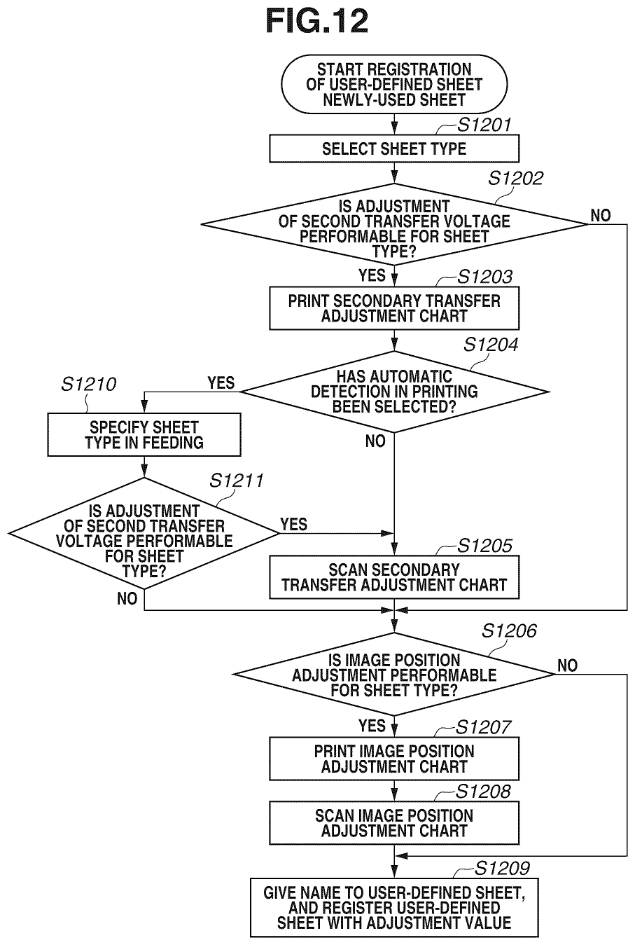

FIG. 12 is a flowchart illustrating a method for controlling the image forming apparatus 201. A control flow of user-defined sheet creation is described with reference to the flowchart in FIG. 12. Steps in the flowchart illustrated in FIG. 12 are performed when the CPU 10 executes control programs read out from the ROM 11 and loaded to the RAM 12.

In step S1201, when placement of a sheet on the sheet feeding tray 5 is detected, the CPU 10 performs control to display the sheet setting screen illustrated in FIG. 8A. When the “newly-used sheet” button 801 is pressed, the CPU 10 performs control to display the screen illustrated in FIG. 8B.

When a sheet type as a copy source is selected by using the “automatic detection in printing” button 802 or from the sheet type list 804, and the “next” button 805 is pressed, the processing proceeds to step S1202. At this time, selection of a sheet type as a copy source means selection of the “automatic detection in printing” button 802 or selection from the sheet type list 804 illustrated in FIG. 8B.

In step S1202, the CPU 10 determines whether the sheet type selected in step S1201 is a sheet type for which the adjustment of the secondary transfer voltage is performable. In a case where the CPU 10 determines in step S1202 that the sheet type is a sheet type for which the adjustment of the secondary transfer voltage is not performable (NO in step S1202), the adjustment of the secondary transfer voltage is skipped, and the processing proceeds to step S1206. In contrast, in a case where the CPU 10 determines in step S1202 that the sheet type is a sheet type for which the adjustment of the secondary transfer voltage is performable (YES in step S1202), the processing proceeds to step S1203. In a case where the “automatic detection in printing” button 802 has been selected in step S1201, the processing proceeds to step S1203.

In step S1203, the CPU 10 performs control to display the secondary transfer adjustment print screen illustrated in FIG. 9A. When the print start button 906 is pressed, the CPU 10 feeds a sheet from the sheet feeding tray 5 and starts print processing of the secondary transfer adjustment chart based on the print control parameters of the sheet type selected in step S1201. In the case where the “automatic detection in printing” button 802 has been selected in step S1201, the CPU 10 performs control to feed a sheet on the sheet feeding tray 5 to the conveyance path.

In step S1204, the CPU 10 determines whether the “automatic detection in printing” button 802 has been selected in step S1201. In other words, the CPU 10 determines whether the “automatic detection in printing” button 802 has been selected or a sheet type in the sheet type list 804 has been selected in FIG. 8B. In a case where the CPU 10 determines that the “automatic detection in printing” button 802 has been selected (YES in step S1204), the processing proceeds to step S1210. In contrast, in a case where the CPU 10 determines that a sheet type in the sheet type list 804 has been selected (NO in step S1204), the processing proceeds to step S1205.

In step S1210, the CPU 10 specifies the sheet type of a sheet on the conveyance path of the sheet feeding tray 5, which is detected by the media sensor 14 when the sheet is fed from the sheet feeding tray 5. Thereafter, the processing proceeds to step S1211.

In step S1211, the CPU 10 determines whether the sheet type specified in step S1210 is a sheet type for which the adjustment of the secondary transfer voltage is performable. In a case where the CPU 10 determines that the sheet type is a sheet type for which the adjustment of the secondary transfer voltage is not performable (NO in step S1211), the CPU 10 does not print the secondary transfer adjustment chart, and the processing proceeds to step S1206. In contrast, in a case where the CPU 10 determines that the sheet type is a sheet type for which the adjustment of the secondary transfer voltage is performable (YES in step S1211), the CPU 10 prints the secondary transfer adjustment chart based on the print control parameters of the sheet type on the sheet feeding tray 5 detected by the media sensor 14, and the processing proceeds to step S1205.

In step S1205, the CPU 10 displays the scan screen for the secondary transfer adjustment chart illustrated in FIG. 9B. In response to pressing of the reading start button 907 illustrated in FIG. 9B, the CPU 10 scans the printed secondary transfer adjustment chart and calculates an adjustment value for the secondary transfer voltage based on a result of the scan. The CPU 10 stores the calculated adjustment value as a print control parameter of the sheet type. Thereafter, the processing proceeds to step S1206.

In step S1206, in a case where a sheet type in the sheet type list 804 has been selected in step S1201, the CPU 10 determines whether the selected sheet type is a sheet type for which the image position adjustment is performable. In addition, in a case where the “automatic detection in printing” button 802 has been selected in step S1201, the CPU 10 determines whether the sheet type specified in step S1210 is a sheet type for which the image position adjustment is performable. In a case where the CPU 10 determines that the sheet type is a sheet type for which the image position adjustment is not performable (NO in step S1206), the processing proceeds to step S1209. In contrast, in a case where the CPU 10 determines that the sheet type is a sheet type for which the image position adjustment is performable (YES in step S1206), the processing proceeds to step S1207.

In step S1207, the CPU 10 performs control to display the image position adjustment print screen illustrated in FIG. 10A. When the print start button 1008 is pressed, the CPU 10 feeds a sheet from the sheet feeding tray 5 and prints the image position adjustment chart based on the print control parameters of the sheet type selected in step S1201. In the case where the “automatic detection in printing” button 802 has been selected in step S1201, the CPU 10 prints the image position adjustment chart based on the print control parameters of the sheet type specified in step S1210. Thereafter, the processing proceeds to step S1208.

In step S1208, the CPU 10 displays the image position adjustment scan screen illustrated in FIG. 10B. In response to pressing of the reading start button 1009 illustrated in FIG. 10B, the CPU 10 scans the printed image position adjustment chart and calculates an adjustment value for the image position adjustment based on a result of the scan. The CPU 10 stores the calculated adjustment value as a print control parameter of the sheet type. Thereafter, the processing proceeds to step S1209.

In step S1209, the CPU 10 performs control to display the screen illustrated in FIG. 11A and receives an input in the name entry field 1110. The CPU 10 registers the sheet type, which is the copy source, selected in step S1201 as a user-defined sheet having the name entered in the name entry field 1110. In a case where an adjustment value for the secondary transfer voltage has been stored in step S1205, the CPU 10 reflects the adjustment value for the secondary transfer voltage in the sheet type of the copy source, and registers the sheet type of the copy source as the user-defined sheet having the name entered in the name entry field 1110. In a case where an adjustment value for the image position adjustment has been stored in step S1208, the CPU 10 reflects the adjustment value for the image position adjustment in the sheet type of the copy source, and registers the sheet type of the copy source as the user-defined sheet having the name entered in the name entry field 1110. Thereafter, the processing in the flowchart illustrated in FIG. 12 ends.

In the present exemplary embodiment, the adjustment of the secondary transfer voltage and the image position adjustment are performed in this order, but may be performed in reverse order. Further, although only the secondary transfer voltage adjustment and the image position adjustment are described as examples, necessary adjustment among the other adjustment menus can be similarly determined and performed based on a sheet type.

In a case where the secondary transfer voltage adjustment is not performable for the sheet type in step S1202 or S1211, the CPU 10 may stop the user-defined sheet registration flow without giving a name in step S1209. In a case where the secondary transfer voltage adjustment is not performable for the sheet type in step S1202 or S1211 and the image position adjustment is not performable for the sheet type in step S1206, the CPU 10 may stop the user-defined sheet registration flow without giving a name in step S1209.

In step S1201, the CPU 10 performs control to display the sheet setting screen illustrated in FIG. 8A. In the sheet setting screen illustrated in FIG. 8A, the sheet size and the sheet type for the sheet feeding tray 5 are settable. In a case where “automatic detection” is set to the sheet size, the CPU 10 detects the sheet size of a sheet placed on the sheet feeding tray 5 based on a width of a slide guide of the sheet feeding tray 5, as illustrated in FIG. 8A. In steps S1202, S1206, and S1211, the CPU 10 may determine whether the sheet type is a sheet type for which the secondary transfer voltage adjustment or the image position adjustment is performable, based on at least one of the sheet type and the sheet size.

As described above, in step S1202 or S1211, the CPU 10 functions as a determination unit, and determines whether a sheet having first sheet information is a sheet for which adjustment of a first print control parameter is performable. The first print control parameter is, for example, a secondary transfer voltage or an image position.

In the case of step S1202, the first sheet information is sheet information selected from sheet information registered in the sheet type list 804 illustrated in FIG. 8B. In the case of step S1211, the first sheet information is sheet information acquired by detection of a sheet placed on the sheet feeding tray 5. The first sheet information is not limited to a sheet type. The first sheet information includes a sheet type or a sheet size. Alternatively, the first sheet information may include both of a sheet type and a sheet size.

In a case where the sheet having the first sheet information is a sheet for which the adjustment of the first print control parameter is performable, the CPU 10 performs control to print a first adjustment chart in step S1203 or S1211. Thereafter, in step S1205, the CPU 10 functions as an acquisition unit, performs control to scan the printed first adjustment chart, and acquires an adjustment value for the first print control parameter based on a result of the scan.

In a case where the sheet having the first sheet information is a sheet for which the adjustment of the first print control parameter is not performable, the CPU 10 performs control not to print the first adjustment chart, and performs control not to scan the first adjustment chart.

In step S1209, the CPU 10 functions as a registration unit. In a case where the adjustment value for the first print control parameter has been acquired in step S1205, the CPU 10 registers second sheet information that is obtained by reflecting the adjustment value for the first print control parameter in the first sheet information.

In step S1210, the CPU 10 detects a sheet type of a sheet on the conveyance path conveyed from the sheet feeding tray 5 when the first adjustment chart is printed, as the first sheet information. In step S1201 or S1210, the CPU 10 detects at least one of the sheet type and the sheet size of the sheet placed on the sheet feeding tray 5, as the first sheet information.

In step S1206, the CPU 10 determines whether the sheet having the first sheet information is a sheet for which adjustment of a second print control parameter is performable. In a case where the sheet having the first sheet information is a sheet for which the adjustment of the second print control parameter is performable, the CPU 10 performs control to print a second adjustment chart in step S1207. Thereafter, in step S1208, the CPU 10 performs control to scan the printed second adjustment chart and acquires an adjustment value for the second print control parameter based on a result of the scan.

In step S1209, in a case where the adjustment value for the second print control parameter has been acquired in step S1208, the CPU 10 registers the second sheet information obtained by reflecting the adjustment value for the second print control parameter in the first sheet information.

After registration in step S1209, as illustrated in FIG. 11B, the second sheet information is set to the sheet feeding tray 5. Thereafter, the CPU 10 functions as a control unit, and performs control to perform printing on the sheet on the sheet feeding tray 5 based on a print job according to the first print control parameter and the second print control parameter.

As described above, according to the present exemplary embodiment, when a user-defined sheet is registered, the CPU 10 can perform adjustment of print control parameters, such as an adjustment value for the secondary transfer voltage and an adjustment value for the image position, and stores their optimum adjustment values as print control parameters of the user-defined sheet. As a result, the image forming apparatus 201 can create a printed document with high quality.

The disclosure of the present exemplary embodiment includes the following configurations, method, and program.

### (Configuration 1)

An image forming apparatus including:
a determination unit configured to determine whether a sheet having first sheet information is a sheet for which adjustment of a first print control parameter is performable;
an acquisition unit configured to, in a case where the sheet having the first sheet information is a sheet for which the adjustment of the first print control parameter is performable, perform control to print a first adjustment chart, perform control to scan the printed first adjustment chart, and acquire an adjustment value for the first print control parameter based on a result of a scan; and
a registration unit configured to, in a case where the first acquisition unit acquires the adjustment value for the first print control parameter, register second sheet information obtained by reflecting the adjustment value for the first print control parameter in the first sheet information.

### (Configuration 2)

The image forming apparatus according to configuration 1, in which the first sheet information is sheet information selected from registered sheet information.

### (Configuration 3)

The image forming apparatus according to configuration 1, in which the first sheet information is sheet information acquired by detection of a sheet placed on a sheet feeding unit.

### (Configuration 4)

The image forming apparatus according to configuration 1, in which the first sheet information includes a sheet type or a sheet size.

### (Configuration 5)

The image forming apparatus according to configuration 1, in which the first sheet information includes a sheet type and a sheet size.

### (Configuration 6)

The image forming apparatus according to configuration 1, in which the first acquisition unit detects a sheet type of a sheet on a conveyance path conveyed from a sheet feeding unit when the first adjustment chart is printed, as the first sheet information.

### (Configuration 7)

The image forming apparatus according to configuration 1, in which the first acquisition unit detects at least one of a sheet type and a sheet size of a sheet placed on a sheet feeding unit, as the first sheet information.

### (Configuration 8)

The image forming apparatus according to any one of configurations 1 to 7, wherein:
the determination unit is further configured to determine whether the sheet having the first sheet information is a sheet for which adjustment of a second print control parameter is performable; and
the acquisition unit is configured to, in a case where the sheet having the first sheet information is a sheet for which the adjustment of the second print control parameter is performable, perform control to print a second adjustment chart, perform control to scan the printed second adjustment chart, and acquire an adjustment value for the second print control parameter based on a result of a scan,
in which, in a case where the second acquisition unit acquires the adjustment value for the second print control parameter, the registration unit registers the second sheet information obtained by reflecting the adjustment value for the second print control parameter in the first sheet information.

### (Configuration 9)

The image forming apparatus according to any one of configurations 1 to 8, in which the first print control parameter is a secondary transfer voltage or an image position.

### (Configuration 10)

The image forming apparatus according to any one of configurations 1 to 9, in which, in a case where the sheet having the first sheet information is a sheet for which the adjustment of the first print control parameter is not performable, the first acquisition unit performs control not to print the first adjustment chart, and performs control not to scan the first adjustment chart.

### (Configuration 11)

The image forming apparatus according to any one of configurations 1 to 10, further including a control unit configured to perform printing on a sheet based on the first print control parameter after registration by the registration unit.

### (Configuration 12)

The image forming apparatus according to any one of configurations 1 to 11, in which, when placement of a sheet on a sheet feeding unit is detected, the determination unit determines whether the sheet having the first sheet information is a sheet for which the adjustment of the first print control parameter is performable.

### (Method 1)

A method for controlling an image forming apparatus, the method including:
determining whether a sheet having first sheet information is a sheet for which adjustment of a first print control parameter is performable;
in a case where the sheet having the first sheet information is a sheet for which the adjustment of the first print control parameter is performable, performing control to print a first adjustment chart, performing control to scan the printed first adjustment chart, and acquiring an adjustment value for the first print control parameter based on a result of a scan; and
in a case where the adjustment value for the first print control parameter is acquired, registering second sheet information obtained by reflecting the adjustment value for the first print control parameter in the first sheet information.

### (Program 1)

A program for causing a computer to function as the image forming apparatus according to any one of configurations 1 to 12.

According to the present exemplary embodiment, it is possible to easily register adjustment values for print control parameters when sheet information is registered.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-134174, filed Aug. 21, 2023, which is hereby incorporated by reference herein in its entirety.

What is claimed is:

1. An image forming apparatus, comprising:
one or more memories that store a set of instructions;
one or more processors that execute the set of instructions to:
determine whether a sheet having first sheet information is a sheet for which adjustment of a first print control parameter is performable;
perform, in a case where the sheet having the first sheet information is a sheet for which the adjustment of the first print control parameter is performable, control to print a first adjustment chart and control to scan the printed first adjustment chart, and acquire an adjustment value for the first print control parameter based on a result of a scan; and
register, in a case where the adjustment value for the first print control parameter is acquired, second sheet information obtained by reflecting the adjustment value for the first print control parameter in the first sheet information.

2. The image forming apparatus according to claim 1, wherein the first sheet information is sheet information selected from registered sheet information.

3. The image forming apparatus according to claim 1, wherein the first sheet information is sheet information acquired by detection of a sheet placed on a sheet feeding unit.

4. The image forming apparatus according to claim 1, wherein the first sheet information includes a sheet type or a sheet size.

5. The image forming apparatus according to claim 1, wherein the first sheet information includes a sheet type and a sheet size.

6. The image forming apparatus according to claim 1, wherein the one or more processors execute the set of instructions to
detect, as the first sheet information, a sheet type of a sheet on a conveyance path conveyed from a sheet feeding unit when the first adjustment chart is printed.

7. The image forming apparatus according to claim 1, wherein the one or more processors execute the set of instructions to
detect, as the first sheet information, at least one of a sheet type or a sheet size of a sheet placed on a sheet feeding unit.

8. The image forming apparatus according to claim 1, wherein the one or more processors execute the set of instructions to
determine whether the sheet having the first sheet information is a sheet for which adjustment of a second print control parameter is performable;
perform, in a case where the sheet having the first sheet information is a sheet for which the adjustment of the second print control parameter is performable, control to print a second adjustment chart and control to scan the printed second adjustment chart, and acquire an adjustment value for the second print control parameter based on a result of a scan; and
register, in a case where the adjustment value for the second print control parameter is acquired, the second sheet information obtained by reflecting the adjustment value for the second print control parameter in the first sheet information.

9. The image forming apparatus according to claim 1, wherein the first print control parameter is a secondary transfer voltage or an image position.

10. The image forming apparatus according to claim 1, wherein the one or more processors execute the set of instructions to control, in a case where the sheet having the first sheet information is a sheet for which the adjustment of the first print control parameter is not performable, not to print the first adjustment chart and not to scan the first adjustment chart.

11. The image forming apparatus according to claim 1, wherein the one or more processors execute the set of instructions to:
perform printing on a sheet based on the first print control parameter after registration.

12. The image forming apparatus according to claim 1, wherein the one or more processors execute the set of instructions to:
determine, when placement of a sheet on a sheet feeding unit is detected, whether the sheet having the first sheet information is a sheet for which the adjustment of the first print control parameter is performable.

13. A method for controlling an image forming apparatus, the method comprising:
determining whether a sheet having first sheet information is a sheet for which adjustment of a first print control parameter is performable;
performing, in a case where the sheet having the first sheet information is a sheet for which the adjustment of the first print control parameter is performable, control to print a first adjustment chart and control to scan the printed first adjustment chart, and acquiring an adjustment value for the first print control parameter based on a result of a scan; and
registering, in a case where the adjustment value for the first print control parameter is acquired, second sheet information obtained by reflecting the adjustment value for the first print control parameter in the first sheet information.

14. A non-transitory computer-readable storage medium storing a program for causing an image forming apparatus to execute a method, the method comprising:
determining whether a sheet having first sheet information is a sheet for which adjustment of a first print control parameter is performable;
performing, in a case where the sheet having the first sheet information is a sheet for which the adjustment of the first print control parameter is performable, control to print a first adjustment chart and control to scan the printed first adjustment chart, and acquiring an adjustment value for the first print control parameter based on a result of a scan; and
registering, in a case where the adjustment value for the first print control parameter is acquired, second sheet information obtained by reflecting the adjustment value for the first print control parameter in the first sheet information.
